(19) United States
(12) Patent Application Publication
(10) Pub. No.: US 2016/0224378 A1
(43) Pub. Date: Aug. 4, 2016

(54) METHOD TO CONTROL DEPLOYMENT OF A PROGRAM ACROSS A CLUSTER OF MACHINES

(71) Applicant: MORPHO, ISSY LES MOLINEAUX (FR)

(72) Inventors: Woody Alan Ulysse ROUSSEAU, ISSY LES MOLINEAUX (FR); Laurent Jean Jose LE CORRE, ISSY LES MOLINEAUX (FR)

(21) Appl. No.: 15/012,648

(22) Filed: Feb. 1, 2016

(30) Foreign Application Priority Data
Feb. 2, 2015 (FR) 1550803

(51) Int. Cl. G06F 9/50; G06F 9/445

(52) U.S. Cl. CPC G06F 9/5005; G06F 8/61; G06F 8/62

(57) ABSTRACT

The invention deals with a method to control deployment of a program to be executed across a cluster of machines (M1-Mn), the method comprising steps of:
measuring (102) an amount of available material resources at each machine (M1-Mn),
determining (306) processes (P1-P5) of the program to be executed in parallel,
for each process (P1-P5), estimating (308) an amount of material resources required for execution of the process,
allocating (400) processes (P1-P5) to machines in the cluster on the basis of the amounts of measured material resources at each of the different machines and the estimated amounts of required resources,
requesting installing a process allocated to a machine in said machine, if the process is not already installed in said machine.

### GENERAL FIELD

The invention concerns a method to control deployment of a program across a cluster of machines.

### STATE OF THE ART

In the state of the art distributed computing systems are known comprising a plurality of separate computers.

These systems are capable of implementing one same program in distributed manner i.e. by delegating to the different computers or “machines” the performing in parallel of different processes of this program.

Each machine comprises material resources able to participate in execution of this program.

One particular problem which arises in said distributed system is the dynamic management of material resources when the program is already in the progress of being executed.

Let us suppose that at reference time t the program requires the execution of a certain number of processes in parallel, which necessitates a theoretical amount of material resources. If at this time t the program is executed by an amount of material resources lower than the theoretical amount, then the program is executed under failsoft conditions.

A distributed system is known which detects that the amount of material resources of one of the computers in the system has reached 100% use. In response to this detection, this system places demand on an additional machine not yet in use to carry out the tasks which were unable to be implemented.

However, the allocation of an additional machine is a rough-and-ready solution since heavy on consumption of number of computers whereas it may not truly be necessary. It is effectively possible that the accumulated amount of material resources of the computers already in use is lower than the total theoretical amount required by the program even if the material resources of one of the computers has reached 100% use.

For instance, document US 2006/0048157 discloses a method for scheduling jobs across a cluster of machines. This method allocates “jobs” to be executed by machines of the cluster.

### DISCLOSURE OF THE INVENTION

It is one objective of the invention to obtain dynamic allocation of the processes of a program to be executed by machines in a manner which demands a fewer number of machines than methods known in the prior art.

A method is therefore proposed to control deployment of a program to be executed across a cluster of machines, the method comprising steps of:
measuring an amount of available material resources at each machine,
determining processes of the program to be executed in parallel,
for each process, estimating an amount of material resources required for execution of the process,
allocating processes to machines in the cluster on the basis of the amounts of measured material resources at each of the different machines and the estimated amounts of required resources,
requesting installing a process allocated to a machine in said machine, if the process is not already installed in said machine.

The invention can also be completed with the following characteristics taken alone or in any technically possible combination.

If a given process of the program is already being executed by a given machine of the cluster and if said given process is not part of the processes determined to be processed, the method may comprise requesting uninstalling said process from said given machine.

If a given process of the program is already being executed by a given machine of the cluster and if said given process is not allocated to said machine, the method may comprise requesting uninstalling said given process from said given machine.

The method may comprise a step to measure a quality of service of the program throughout its execution by the cluster of machines, the processes of the program to be executed being determined on the basis of measured quality of service and a predetermined set quality of service.

The method may further comprise a step of predicting an amount of material resources consumed by the cluster of machines at a reference time, on the basis of the measured amounts of material resources during a time period prior said reference time, wherein determining processed to be executed at said reference time depends on said predicted amount of material resources consumed by the cluster.

The method may further comprise the following steps implemented in the event of failure of the allocation step:
adjusting the set service quality to a failsoft value in relation to its preceding value;
implementing the steps to determine processes to be executed and allocation thereof on the basis of the adjusted set quality of service.

Measurement of quality of service of the program may comprise:
measurement of a response time of the program to a request sent by at least one item of network equipment, when being executed by the cluster of machines, and/or
measurement of a number of requests sent by at least one item of equipment network which are processed per unit of time by the program when being executed by the cluster of machines, and/or
measurement of an availability time during which the program is able to process external requests within a predetermined period of time, when being executed by the cluster of machines.

The method may further comprise a step to predict amounts of material resources consumed by the cluster of machines at a reference time, on the basis of amounts of material resources measured during a time interval preceding the reference time, the determination of the processes to be executed at the reference time depending on the predicted amounts of consumed material resources.

Prediction may comprise the search and detection of a periodic pattern in the amounts of measured material resources during the interval of time, the amounts of required material resources depending on the detected periodic pattern.

Allocation may comprise comparison between amounts of measured resources and amounts of required resources, allocation depending on the results of these comparisons.

The allocation of determined processes may also be carried out in sequence, machine after machine.

Determined processes can be allocated to a machine, called current machine, for as long as the accumulation of amounts of material resources required for execution of processes already allocated to the current machine remain lower than the amount of available material resources of the current machine.

A second aspect of the invention is a computer program product comprising program code instructions to implement steps of the aforementioned deployment control method when this program is executed by a server.

This program may also comprise the code instructions of the processes to be executed by the cluster of machines.

According to a third aspect, the invention proposes a server comprising:
a communication interface to communicate with a cluster of machines,
a memory memorizing a target program to be executed by machines of said cluster,
a deployment unit configured to:
   measure an amount of available material resources at each machine,
   determine processes of the target program to be executed in parallel,
   for each process, estimate an amount of material resources required to execute the process,
   allocate the processes to machines in the cluster on the basis of measured amounts of material resources at each of the different machines and estimated amounts of required resources,
   request installing a process allocated to a machine in said machine, if the process is not already installed in said machine.

This server can be used as one of the machines in the cluster of machines executing the target program.

### DESCRIPTION OF THE FIGURES

Other characteristics, objectives and advantages of the invention will become apparent from the following description which is solely illustrative and non-limiting and is to be read in connection with the appended drawings in which:

FIG. 1 schematically illustrates a program deployment network comprising a cluster of machines to execute a target program.

FIG. 2 illustrates functional modules of a deployment program according to one embodiment of the invention.

FIG. 3 is a flow chart of the steps of a method implemented by the functional modules illustrated in FIG. 2.

FIG. 4 details an allocation step of the flow chart in FIG. 3 according to one embodiment of the invention.

FIG. 5 schematically illustrates an example of material resources required by processes to be executed, available material resources of machines and allocations of these processes to the machines.

In all the Figures like elements carry like references.

### DETAILED DESCRIPTION OF THE INVENTION

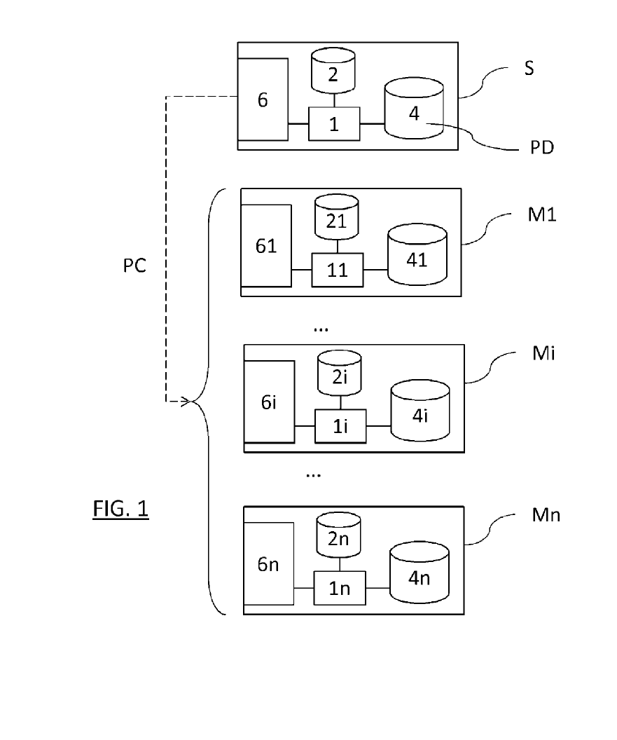

With reference to FIG. 1, a deployment server S comprises a data processing unit 1, buffer memory 2, storage memory 4, and a network communication interface 6.

The data processing unit 1 typically comprises one or more processors adapted to operate in parallel. Each processor is adapted to carry out program code instructions.

The storage memory 4 is adapted to memorize one or more programs and data and to store the same even after the server S is switched off.

The storage memory 4 may comprise one or discs for example of hard disc type, one of more discs of SSD type (Solid State Drive) or a combination of these types of disc. The storage memory unit 4 may comprise one or more discs permanently integrated in the server S and/or may comprise one or more removable memory sticks having a connector of USB or other type.

The buffer memory 2 is configured to memorize temporary data during the execution of a program by the processing unit 1. The temporary data memorized by the buffer memory 2 are automatically deleted when the server S is switched off. The buffer memory 2 comprises one or more RAM memory modules for example.

The communication interface 6 is adapted to transmit and receive data over the network. This interface 6 may of wire or wireless type (e.g. capable of communicating via Wi-Fi).

A deployment network is described below which, in addition to the deployment server S, comprises a physical cluster of computers M1 to Mn called “machines” in the remainder hereof.

The deployment network may be a private network or public network such as the Internet.

The deployment network is such that the server S is able to communicate with each machine Mi of the cluster.

Each machine Mi in the cluster typically comprises the same components as the deployment server S. More specifically, a machine Mi of subscript i comprises a data processing unit 1i, at least one storage memory 4i, at least one buffer memory 2i and a network communication interface 6i. Each of these components may be similar to the corresponding component of the server S (i.e. the component having the same reference number but without the suffix i).

### Material Resources

The material resources of a machine Mi (or of the server S) relate to the components of the machine Mi defined above which take part in the execution of a given program.

These material resources may be of different types, each type of resource being quantifiable.

One first type of material resource is a processor time, or time of use, or level of use representing a degree of demand placed on a processor in the processing unit 1i to execute processes. Said processor time is generally presented to a user by the monitoring program in the form of at least one value in percent, each value relating to a level of use of a respective processor in the data processing unit 1i (0% indicating a processor on which no demand is placed and 100% indicating a processor unable to receive any more demands in particular for execution of an additional process). A second type of material resource is a memory size relating to the buffer memory 2i or storage memory 4i. Said size is expressed in megaoctets for example.

A third type of material resource is a network bandwidth which relates to the network communication interface 6i.

Consideration will now be given to two computer programs: a target program PC and a deployment program PD of the target program PC. As will be seen below, these two computer programs can form two parts of one and the same computer program.

### Target Program

The target program PC is a program intended to be executed in distributed manner by the cluster of machines M1-Mn. This target program PC comprises code instruction blocks forming processes able to be executed simultaneously by the machines M1-Mn.

Each process ensures a particular function.

By convention, it will be considered in the remainder hereof that a process of the target program PC can be executed by a single or by several processors. A process may in fact comprise one or more tasks or instruction threads in the meaning of the standard (term and definition standardized by ISO/CEI 2382-7:2000).

A task is similar to a process since both represent the execution of a set of instructions in the machine language of a processor. From the user's point of view, these executions appear to be carried out in parallel. However when each process has its own virtual memory, the threads of one same process share its virtual memory. On the other hand, all the threads have their own call stack.

It is pointed out that during their execution some processes may command transmission of data to a third party server connected to the machine(s) executing the same and/or the receiving of data from said third party server. By convention, these particular processes will be called “network processes” in the remainder hereof.

### Deployment Program PD

The main function of the deployment program PD is to control the deployment and execution of the target program PC by all or some of the machines M1 to Mn in the cluster.

The deployment program is installed in the memory 4 of the server S and implemented by the processing unit 1.

The target program PC and the deployment program PD may be separate programs installable independently of one another, or they may be in the form of one and the same installable monolithic code. In this latter case, the monolithic PC-PD program is installed in the memory 4i of each machine M1-Mn; the deployment part “PD” of this monolithic program will only be executed however by the processing unit 1 of the server S.

The data processing unit 1 is adapted to implement the deployment program PD which is previously memorized in the memory 4.

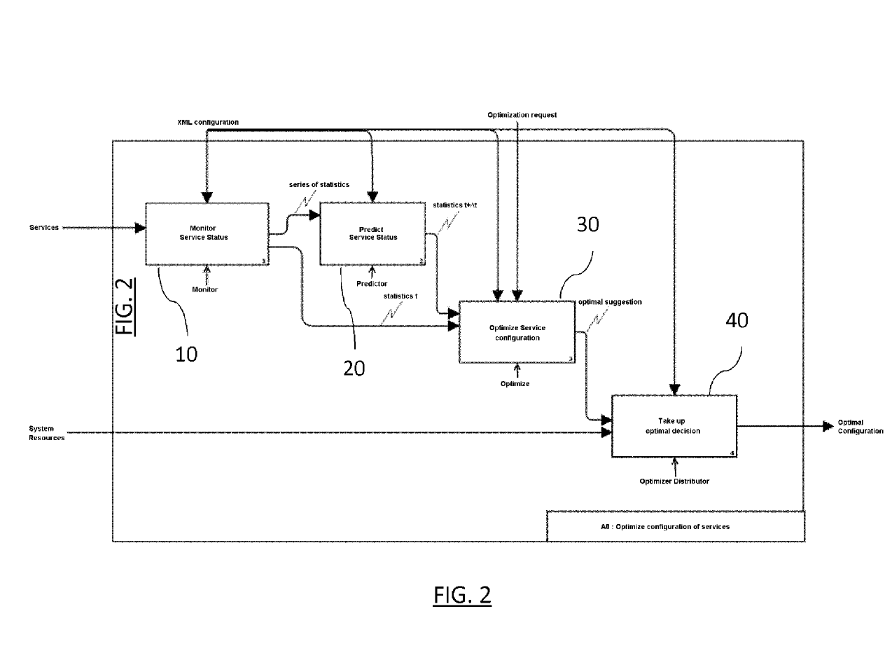

With reference to FIG. 2, the deployment program PD comprises different functional modules: a monitoring module 10, prediction module 20, optimization module 30 and allocation module 40.

The monitoring module 10 is configured to monitor the state of material resources of the machines M1-Mn, and to provide statistical data to the prediction 20 and/or optimization 30 modules.

The prediction module 20 is adapted to communicate with the monitoring module; it uses the statistical data provided by the monitoring module to carry out predictive computations.

The optimization module 30 is adapted to communicate first with the prediction module and secondly with the monitoring module. The optimization module is particularly configured to determine the processes of the target program PC to be executed, as a function of data sent by the monitoring module and/or prediction module and by an optimization mechanism.

The process(es) to be executed determined by the optimization module form an “optimal” suggestion of execution given to the allocation module 40 having regard to the available capacities of the cluster of machines.

The allocation module 40 is adapted to communicate with the optimization module. It is configured to allocate the processes selected by the optimization module to the machines in the cluster, for execution thereof.

The allocation module 40 produces data representing an allocation of each process selected by the optimization module to a machine of the cluster.

The four modules 10, 20, 30, 40 can be parameterized by an XML configuration file.

### Quality of Service of the Cluster of Machines

In the remainder hereof quality of service (abbreviated to “QoS” in the literature) of the target program PC executed across a cluster of machines, is defined as one or more quantifiable metrics which evaluate the conditions of data communication in a determined network, when the cluster of machine executes the target program PC.

This determined network may be the deployment network itself or else another network.

The quality of service of the target program PC and machine cluster assembly is represented by at least one of the following data items:
a number of requests per unit of time processed by the target program executed by the cluster of machines (sent for example by at least one third party network equipment).
a response time of the target program when executed by the machine cluster to a standardized message, a request (transmitted for example by at least one item of equipment outside the cluster) expressed in milliseconds for example.
an availability time during which the target program is capable of processing the number of external requests per unit of time in a predefined response time, over a predetermined time period.

It will be understood that quality of service may depend on the extent of demand placed on the different machines in the cluster to execute programs and in particular the target program PC.

### Deployment Method of the Target Program

A method is now described for deployment of the target program PC across the cluster of machines M1-Mn, i.e. to have it executed by all or some of these machines using their respective material resources.

This deployment method is controlled by the deployment program PD.

In one initial state it is assumed that the target program PC is memorized solely in the storage memory 4 of the server S.

The method comprises four main steps:
a step 100 to monitor available resources, implemented by the monitoring module 10;
an optional prediction step 200, implemented by the prediction module 20;
an optimization step 300, implemented by the optimization module 30; and
an allocation step 400, implemented by the allocation module 40.

1. Monitoring of Available Resources in the Cluster of Machines

The monitoring step 100 comprises the following sub-steps.

At step 102, the monitoring module measures an amount of material resources at each of the machines M1-Mn.

The amount of material resources measured at each machine Mi is an available amount of resources i.e. non-used by the machine at the time of measurement.

For example, each measurement 102 may comprise the generation of a monitoring request by the monitoring module which is executed by the processing unit 1 of the server S, the sending of the request to a machine Mi via interface 6 and the receiving of a reply to the request containing the requested available amount.

Measurements 102 are periodically triggered for example by the monitoring module, at a time period Ti for a given machine Mi. The time periods Ti may be the same or different.

The monitoring module time stamps 104 the acquired measurements i.e. it assigns a measurement time to each measured amount of resources. For example, this time may be the time of receipt of the measurement by the processing unit 1 via the communication interface 6 of the server S.

The monitoring module controls memorizing 106 of time-stamped measurements in the storage memory 4 of the S. These time-stamped measurements can be memorized in the form of time series.

Steps 102, 104, 106 above are repeatedly implemented by the monitoring module for each machine Mi, and for several of the types of material resources previously mentioned. As example in the remainder hereof an embodiment will be used in which the first type of resource (processor time) and second type of resource (size of available memory) are monitored throughout the monitoring step 100.

2. Prediction

The prediction module performs 200 computations of stochastic models from the memorized time series. These models may typically be based on double seasonal exponential smoothing.

These stochastic models can be used if the material resources of machines M1-Mn follow a recognizable trend over the days of the week and hours of each day (double seasonality).

To do so, the prediction module searches 202 in the memorized time-stamped measurements for a periodic pattern of demand on resources, for example within a time interval of predetermined length.

On the basis of said pattern, the prediction module estimates 204 material resources that will be consumed by machines M1-Mn at a future time.

For example in one particular application of the method, the deployment network is a private network of an airport and the target program PC to be deployed in the network is a border surveillance program under the control of the airport.

Each arrival of an aircraft gives rise to strong activity within the airport and hence to strong demand on the material resources of the cluster of machines M1-Mn. Therefore, if measurements are memorized over a sufficiently long time period (at least one week) and at sufficiently high frequency (several measurements per day), the prediction module has sufficient data available for accurate prediction of a future demand on the cluster of machines M1-Mn.

To prevent corruption of the prediction models by “abnormal” days (holidays, strikes, etc.), learning techniques can be used by the prediction module. Analysis of main components is performed on a set of recent days for projection along these components. A criterion of distance to nearest neighbor is used to detect abnormal days. These days are reconstructed one by one applying the stochastic model used by the prediction module.

3. Objective-based Optimization

As a preliminary, a set quality of service is memorized in the optimization module which the target program PC must heed when it is executed by the cluster of machines. This set value comprises a minimum data rate for example and a maximum response time value.

In addition, the optimization module measures 302 a quality of service of the program in the progress of being executed by the cluster of machines.

The optimization module determines 306, at a reference time t, a set of processes to be simultaneously executed on the basis of the following data:
the set quality of service,
the quality of service measured at step 302,
estimations of demand on material resources computed by the prediction module for this time t, or else unprocessed measurements produced by the monitoring module in one embodiment without prediction module.

The number of processes determined by the optimization module varies as a function of these data.

For each process of the determined set, the optimization module determines 308 a required amount of material resources for nominal execution of the process.

4. Allocation of Processes to Machines in the Cluster

From the monitoring module (or prediction module if any) the allocation module receives a stated amount of available resources machine by machine at reference time t or at a close time.

From the optimization module, the allocation module receives:
the set of processes determined at step 306,
for each process in the set, a stated required amount of required resources machine by machine at reference time t or at a close time, via step 308.

Each process is associated with a pair of values (required processor time+required memory size), the pair of values representing the amount of resources required for execution thereof. Two types of resources therefore need to be examined.

Allocation 400 is carried out by the allocation module, in successive iterations, machine after machine (for example starting with machine M1).

For a given machine Mi, allocation is performed process by process (starting with P1 for example).

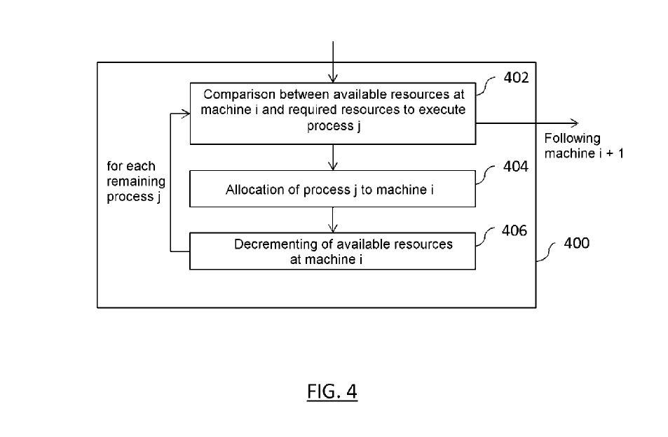

With reference to FIG. 4, the following steps are carried out to determine whether a process Pj is allocated to machine Mi.

The allocation module compares 404 the resources required for execution of process Pj with the stated available resources of machine Mi.

The comparison step 404 more specifically comprises two types of comparison:
A comparison between the processor time value required for execution of process Pj, and the stated available processor time of machine Mi, and
A comparison between the value of the buffer memory size required for execution of process Pj, and the value of buffer memory size stated as being available at machine Mi.

If each of the required values is lower than the corresponding available value at machine Mi, this means that a process of machine Mi has sufficient available resources to execute process Pj under nominal conditions.

In this case, process Pj is allocated 404 to machine Mi. This allocation in practice may comprise memorization of a logic link in the temporary memory 2 representing this allocation.

At all times in this case, the allocation module decrements 406 the amount of available resources of machine Mi by the amount of resources required for process Pj which has just been allocated.

On the other hand, if at least one of the two required values is strictly higher than the corresponding available value compared therewith, process Pj is not allocated to machine Mi; steps 402, 404 and 406 are repeated for another process Pj to be executed and on the basis of the decremented amount of available resources.

Once there are no longer sufficient available resources at machine Mi to allow any allocation of processes remaining to be allocated, the following machine Mi+1 is examined applying the same steps.

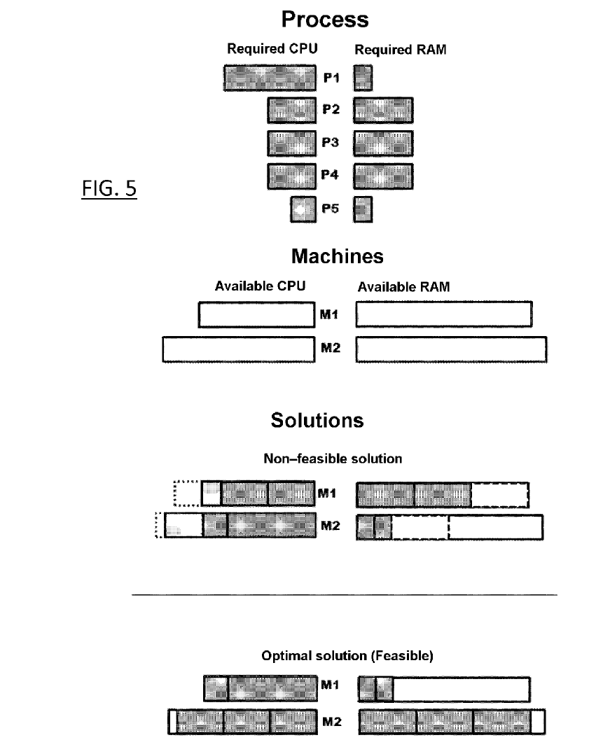

In the example illustrated FIG. 5, five processes P1 to P5 have been determined and are to be allocated across a cluster comprising two machines M1 and M2.

For each process P1 to P5 there is a corresponding amount of required material resources for execution thereof under nominal conditions. The required processor time for execution of process Pj is given in the top left of FIG. 5 (“required CPU”), and the required memory size to memorize temporary data during execution of this same process Pj is schematically illustrated in the top right of FIG. 5 (“required RAM”).

Each of the machines M1 and M2 has an available processor time (“available CPU”, center left in FIG. 5) and an available buffer memory size (“available RAM” center right in FIG. 5).

FIG. 5 also gives two allocation results: one non-feasible and discarded when implementing the steps illustrated in FIG. 4, and the other feasible (bottom of FIG. 5).

It will be noted that one same process, called reference process, may have to be executed several times in parallel by one or more machines in the cluster (i.e. the determined set of processes to be executed may comprise at least one process in several copies).

In this case, the allocation module may receive two numbers of execution of the reference process from the optimization module: a current number of executions (using current material resources), and a number of executions to be taken in charge (by required material resources determined at step 308).

A nonzero difference between these two numbers of executions indicates a number of executions to be allocated or else a number of executions of the reference process to be stopped in the cluster of machines (according to the sign of this difference).

Also, in the embodiment of allocation previously presented all the processes determined and to be allocated are treated on equal terms. As a variant, each process may be assigned a weighting representing priority of execution (e.g. a high process weighting may indicate that it must be allocated first or at least in priority). In this case, the allocation of the weighted processes can be carried out in accordance with a known algorithm meeting a problem of Knapsack type known to persons skilled in the art.

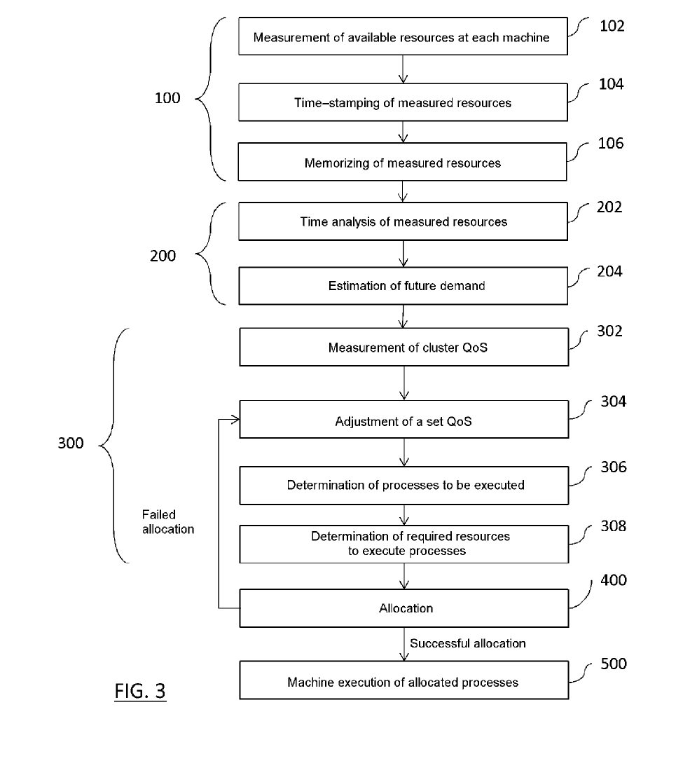

Returning to FIG. 3, allocation 400 is stopped once all the machines have been examined or all processes have been allocated.

Allocation 400 is successfully completed if it has been possible to allocate all processes.

Allocation 400 is a failure if, after examining all the machines, there still remains at least one non-allocated process. This case occurs for example when:
the processor time required for execution of all the determined processes is longer than the sum of the available processor times of all the machines in the cluster; or
the memory size required for execution of all the determined processes is larger than the sum of all available memory sizes of all the machines in the cluster;
one process requires a processor time longer than each of the available processor times of the processors in the cluster;

In the event of failure of the allocation step, the following steps are implemented.

The allocation module sends a message indicating failed allocation to the optimization module.

On receipt of this failure message, the optimization module adjusts 304 the initial set quality of service to a “failsoft” value, i.e. a value representing lesser quality of service than used to determine the set of processes that the allocation module was unable to allocate in its entirety.

For example, at this adjustment step 304, the optimization module reduces the minimum set data rate value that is to be heeded by the cluster of machines and/or increases the maximum set response time to be heeded by the cluster.

Next, the determination step 306 is repeated to produce a new set of processes to be executed by the cluster of machines on the basis of the updating of the set quality of service to “failsoft” value. It will be understood that the obtaining of “failsoft” quality of service by the cluster of machines is less difficult; the new set of determined processes is less difficult to allocate to the cluster machines.

For this new implementation of determination step 306, the quality of service already measured at step 302 can be directly used; as a variant, step 302 is again carried out to obtain a more recent measurement of the quality of service of the target program, the determination step being implemented on the basis of this more recent measurement.

Monitoring response time of the program to a request from at least one network equipment when executed by the cluster, allows controlling such response time. More processes may be allocated to machines to handle the request; the processing time of said request in the cluster will then be reduced. Thus, if it is determined that the response time measured over a prior monitoring period is greater than the predetermined response time set, the number of processes to be executed in order to process this request can be increased. Response time associated with the request will then automatically decrease to a response value smaller that value set.

Moreover, monitoring the number of requests from at least one network equipment that are processed per unit of time allows to globally adjust the number of machines to be used in order to handle all the requests. Indeed, when aggregate demand increases, the number of incoming requests per unit of time increases in the system; it can be expected to deploy the program on more machines than before to process all incoming requests. Similarly, when the amount of incoming requests per unit time decreases, it may be decided, as will be seen below, uninstalling some processes from some machines.

Moreover, monitoring availability during which the program is able to process external requests in a predetermined period of time, when executed by the cluster, has the advantage of allowing to preserve minimal redundancy in the cluster. Redundancy ensures system availability. Indeed, if after a very low demand period the deployment methods uses only one single machine, and if unfortunately this machine is experiencing a hardware problem, then the system becomes unavailable until that processes are deployed onto other machines. On the other hand, based on a predetermined availability set, the method may make sure that no less than 3 instances of each process should be executed at any time and that these instances should be deployed on different machines. In doing so, availability can be guaranteed.

For each new process, a new pair of values (required CPU time+required memory size) can be computed.

In one embodiment, the values (required CPU time+required memory size) are not modified compared with previously: the number of processes to be executed is simply reduced.

The allocation step 400 is then repeated by the allocation module, this time taking as input the new determined set of processes.

In the event of further failure, the adjustment step 304 of the set quality of service, determination step 306 of new processes and allocation step 400 of determined processes are repeated until allocation is successful.

The above-described allocation can be generalized to n machines and p processes.

Once allocation 400 has been successfully carried out, the allocation module sends 500 to each designated machine an execution command of each process allocated thereto.

This execution command may comprise the process code as such if this code is not already memorized in the memory 2i or 41 of the designated machine Mi.

As a variant, the execution command simply comprises an instruction commanding execution by the processing unit 2i of the process previously memorized in memory 2i or memory 4i.

When a process is stored in the storage memory 4i, the process is said to be installed in the machine i.

The method can be implemented repeatedly during the overall execution of the program by the cluster (i.e. the execution of at least one target program process by at least one machine of the cluster).

Processes of the target program can change over time. Moreover, the number of machines on which a given process should be performed in parallel can also change (increase, remain constant, or decrease).

In particular, a given process being executed by at least a given machine i, can no longer be needed, or can require less material resources.

Suppose a given process is running at least the machine i of the cluster.

If this given process given is selected as a process to be executed during a subsequent iteration of determination step 306, then the execution of the process on machine i is stopped, which has the effect of releasing CPU time on this machine i. Moreover, the process is erased from memory 2i. Most advantageously, the process is also erased from storage memory 4i; in other words, the process is uninstalled from the machine i.

The same material resource releasing steps can be implemented whenever a given process being executed by machine i is no longer assigned to machine i during a subsequent allocating step.

In both above-mentioned cases, releasing resources can be implemented by sending, by the assignment module to the respective machine, a process of release request.

When a machine receives a resource release request of a process that is currently running, the machine releases resources. For example, when a machine receives a uninstall request, process execution is stopped and uninstalled from memories 4i and 2i.

In the embodiment presented above, the data processing unit of the server S implements the deployment program PD and thereby ensures a deployment function.

Additionally, it is fully possible that the server S can be used as a machine taking part in execution of the target program PC. Like machines M1-Mn, the server S has material resources.

In this case, the processes allocated to the server S will not be sent across the network but simply downloaded from the memory 4.

1. A method to control deployment of a program to be executed across a cluster of machines, the method comprising steps of:
measuring an amount of available material resources at each machine,
determining processes of the program to be executed in parallel,
for each process, estimating an amount of material resources required for execution of the process,
allocating processes to machines in the cluster on the basis of the amounts of measured material resources at each of the different machines and the estimated amounts of required resources,
requesting installing a process allocated to a machine in said machine, if the process is not already installed in said machine.

2. The method according to claim 1, further comprising:
if a given process of the program is already being executed by a given machine of the cluster and if said given process is not part of the processes determined to be processed, requesting uninstalling said process from said given machine.

3. The method according to claim 1, further comprising:
if a given process of the program is already being executed by a given machine of the cluster and if said given process is not allocated to said machine, requesting uninstalling said given process from said given machine.

4. The method according to claim 1, further comprising measuring quality of service of the program throughout execution thereof by the cluster of machines, the processes of the program to be executed being determined on the basis of measured quality of service and on the basis of a predetermined set quality of service.

5. The method according to claim 4, further comprising the following steps implemented in the event of failure of the allocation step:
adjusting the set quality of service to a failsoft value in relation to its preceding value,
implementing steps of determining processes to be executed and allocation thereof, on the basis of the adjusted set quality of service.

6. The method according to claim 4, wherein measurement of quality of service of the program comprises:
measuring a response time of the program to a request sent by at least one item of network equipment, when being executed by the cluster of machines, and/or
measuring a number of requests sent by at least one item of network equipment which are processed per unit of time by the program when executed by the cluster of machines, and/or
measuring an availability time during which the program is able to process external requests within a predetermined period of time, when being executed by the cluster of machines.

7. The method according to claim 1, further comprising predicting an amount of material resources consumed by the cluster of machines at a reference time, on the basis of the measured amounts of material resources during a time period prior said reference time, wherein determining processed to be executed at said reference time depends on said predicted amount of material resources consumed by the cluster.

8. The method according to claim 7, wherein predicting quantities of material resources consumed comprises searching and detecting a periodic pattern in the amounts of material resources measured during the time interval, wherein the required amounts of material resources depend on the detected periodic pattern.

9. The method according to claim 1, wherein allocating processes comprises comparing measured amounts of resources and required amounts of resources, and wherein the allocated processed depend on the results of said comparing.

10. The method according to claim 1, wherein allocating processes is carried out on a machine per machine basis.

11. The method according to claim 10, wherein processes are allocated to a machine, called current machine, as long as accumulated amounts of material resources required to execute processes already allocated to the current machine remain lower than the amount of available material resources of the current machine.

12. A computer program product comprising program code instructions to execute the steps of the method according to claim 1, when this program is executed by a server.

13. The computer program product according to claim 12, further comprising code instructions of the processes to be executed by the cluster of machines.

14. A server comprising:
a communication interface to communicate with a cluster of machines,
a memory memorizing a target program to be executed by machines of said cluster,
a deployment unit configured to:
measure an amount of available material resources at each machine,
determine processes of the target program to be executed in parallel,
for each process, estimate an amount of material resources required to execute the process,
allocate the processes to machines in the cluster on the basis of measured amounts of material resources at each of the different machines and estimated amounts of required resources,
request installing a process allocated to a machine in said machine, if the process is not already installed in said machine.

15. The use of the server according to claim 14 as a machine in the cluster of machines.
